(19) United States
(12) Patent Application Publication
(10) Pub. No.: US 2017/0013524 A1
(43) Pub. Date: Jan. 12, 2017

(54) METHODS AND SYSTEM IN USER SERVICE ENHANCEMENT FOR ROAMING IN WIRELESS MESH NETWORKS

(71) Applicant: Yin Yee Clara HO, Hong Kong (CN)

(72) Inventors: Yin Yee Clara HO, Hong Kong (CN); Pak Kit LAM, Hong Kong (CN)

(73) Assignee: Yin Yee Clara HO, Hong Kong (CN)

(21) Appl. No.: 15/195,978

(22) Filed: Jun. 28, 2016

(30) Foreign Application Priority Data
Jul. 6, 2015 (HK) 15106434.4

(51) Int. Cl. H04W 36/08; H04W 8/08; H04W 48/20; H04L 29/08; H04L 29/12; H04W 8/24; H04W 48/02

(52) U.S. Cl. CPC H04W 36/08; H04W 8/24; H04W 8/08; H04W 48/02; H04L 67/306; H04L 61/6022; H04W 48/20; H04W 84/18

(57) ABSTRACT

The present disclosure relates to methods and system for enhancing user services during roaming in wireless mesh networks, in particular, a wireless mesh router (“WMR”) for accessing a wireless mesh network. The WMR is to identify neighboring WMRs that are in the neighborhood of said WMR and to store identity information of the neighboring WMRs, and the WMR is to provide the neighboring WMRs with data of a mobile user device while the mobile user device is in connection with the WMR such that one of said neighboring WMRs is to takeover connection of the mobile user device from the WMR when the mobile user device moves away from said WMR.

### CROSS-REFERENCE TO RELATED APPLICATION

This application claims the benefit of Hong Kong Short-term Patent Application No. 15106434.4, filed on Jul. 6, 2015, the entire contents of which are incorporated herein by reference for all purposes.

### BACKGROUND

1. Field

The present disclosure relates to wireless networks, and more particularly to methods and system for enhancing user services during roaming in wireless mesh networks.

2. Description of Related Art

Wireless mesh networks offer a low-cost and scalable way for providing Internet access. A wireless mesh network is built using network relaying devices such as wireless mesh routers (“WMR”), among other possible components. Users can move around in the wireless mesh network and use Internet services with their mobile devices. User services such as firewall rules reside on WMRs of the wireless mesh network to provide various functions, including restricting user access, monitoring user usage, securing the network, and supporting upper layer applications.

A user device roaming across the WMRs in a wireless mesh network may encounter problems when moving from the coverage of one WMR to another. Some user services are user-based and different across WMRs. When the user device moves from the coverage of a first WMR to a second WMR, user services of the second WMR have to be updated. This could lead to a large time delay and result in a poor user experience. For example, for captive portal residing on WMR, users have to log in through a webpage every time their devices roam from a WMR to another. As another example, for intrusion detection, WMR firewalls may be updated via a centralized intrusion prevention system far away, thus requiring the updates to travel a long path along the wireless mesh network.

### BRIEF SUMMARY

In some embodiments, a method for accessing a wireless mesh network comprises: identifying, at a wireless mesh router, a neighboring wireless mesh router that is in communication with the wireless mesh router; storing, at the wireless mesh router, identification data for the neighboring wireless mesh router; sending, from the wireless mesh router to the neighboring wireless mesh router, data of a mobile user device while the mobile user device has a connection with the wireless mesh router, wherein the data of the mobile user device comprises a user profile; and transferring the connection for the mobile user device from the wireless mesh router to the neighboring wireless mesh router, wherein the neighboring wireless mesh network router provides access to the wireless mesh network to the mobile user device based on the data of the mobile user device.

In some embodiments, a method for accessing a wireless mesh network comprises: identifying, at a first wireless mesh router, a neighboring wireless mesh router that is in communication with the wireless mesh router; storing, at the wireless mesh router, identification data for the neighboring wireless mesh router; receiving, from the neighboring wireless mesh router at the wireless mesh router, first data of a mobile user device while the mobile user device has a connection with the neighboring wireless mesh router, wherein the first data of the mobile user device comprises a user profile; transferring the connection for the mobile user device from the neighboring wireless mesh router to the wireless mesh router, wherein the wireless mesh network router provides access to the wireless mesh network to the mobile user device based on the first data of the mobile user device.

In some embodiments, a wireless mesh router for accessing a wireless mesh network comprises: one or more processors; a memory coupled to the one or more processors; and one or more programs, wherein the one or more programs are stored in the memory and configured to be executed by the one or more processors, the one or more programs including instructions for: identifying, at the wireless mesh router, a neighboring wireless mesh router that is in communication with the wireless mesh router; storing, at the wireless mesh router, identification data for the neighboring wireless mesh router; sending, from the wireless mesh router to the neighboring wireless mesh router, data of a mobile user device while the mobile user device has a connection with the wireless mesh router, wherein the data of the mobile user device comprises a user profile; and transferring the connection for the mobile user device from the wireless mesh router to the neighboring wireless mesh router, wherein the neighboring wireless mesh network router provides access to the wireless mesh network to the mobile user device based on the data of the mobile user device.

In some embodiments, a wireless mesh router for accessing a wireless mesh network comprises: one or more processors; a memory coupled to the one or more processors; and one or more programs, wherein the one or more programs are stored in the memory and configured to be executed by the one or more processors, the one or more programs including instructions for: identifying, at the wireless mesh router, a neighboring wireless mesh router that is in communication with the wireless mesh router; storing, at the wireless mesh router, identification data for the neighboring wireless mesh router; receiving, from the neighboring wireless mesh router at the wireless mesh router, first data of a mobile user device while the mobile user device has a connection with the neighboring wireless mesh router, wherein the first data of the mobile user device comprises a user profile; transferring the connection for the mobile user device from the neighboring wireless mesh router to the wireless mesh router, wherein the wireless mesh network router provides access to the wireless mesh network to the mobile user device based on the first data of the mobile user device.

In some embodiments, a non-transitory computer-readable storage medium stores one or more programs, the one or more programs comprising instructions for accessing a wireless mesh network, which when executed by one or more processors of an electronic device, cause the device to: identify, at a wireless mesh router, a neighboring wireless mesh router that is in communication with the wireless mesh router; store, at the wireless mesh router, identification data for the neighboring wireless mesh router; send, from the wireless mesh router to the neighboring wireless mesh router, data of a mobile user device while the mobile user device has a connection with the wireless mesh router, wherein the data of the mobile user device comprises a user profile; and transfer the connection for the mobile user device from the wireless mesh router to the neighboring wireless mesh router, wherein the neighboring wireless mesh network router provides access to the wireless mesh network to the mobile user device based on the data of the mobile user device.

In some embodiments, a non-transitory computer-readable storage medium stores one or more programs, the one or more programs comprising instructions for accessing a wireless mesh network, which when executed by one or more processors of an electronic device, cause the device to: identify, at a first wireless mesh router, a neighboring wireless mesh router that is in communication with the wireless mesh router; store, at the wireless mesh router, identification data for the neighboring wireless mesh router; receive, from the neighboring wireless mesh router at the wireless mesh router, first data of a mobile user device while the mobile user device has a connection with the neighboring wireless mesh router, wherein the first data of the mobile user device comprises a user profile; transfer the connection for the mobile user device from the neighboring wireless mesh router to the wireless mesh router, wherein the wireless mesh network router provides access to the wireless mesh network to the mobile user device based on the first data of the mobile user device.

### DESCRIPTION OF THE FIGURES

FIG. 1 depicts a schematic view of an exemplary wireless mesh network according to an embodiment of the present disclosure.

FIG. 2 depicts a block diagram of an exemplary system for enhancing user services, showing various components in an exemplary WMR according to an embodiment of the present disclosure.

FIG. 3 depicts a flow chart of an exemplary flow of a user profile propagation process according to an embodiment of the present disclosure.

FIG. 4 depicts a flow chart of an exemplary flow of a WMR profile propagation process according to an embodiment of the present disclosure.

FIG. 5 depicts a flow chart of an exemplary flow of data propagation with firewall related services among WMRs according to an embodiment of the present disclosure.

FIG. 6 depicts a schematic diagram of an exemplary WMR profile storage table and an exemplary user profile storage table according to an embodiment of the present disclosure.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

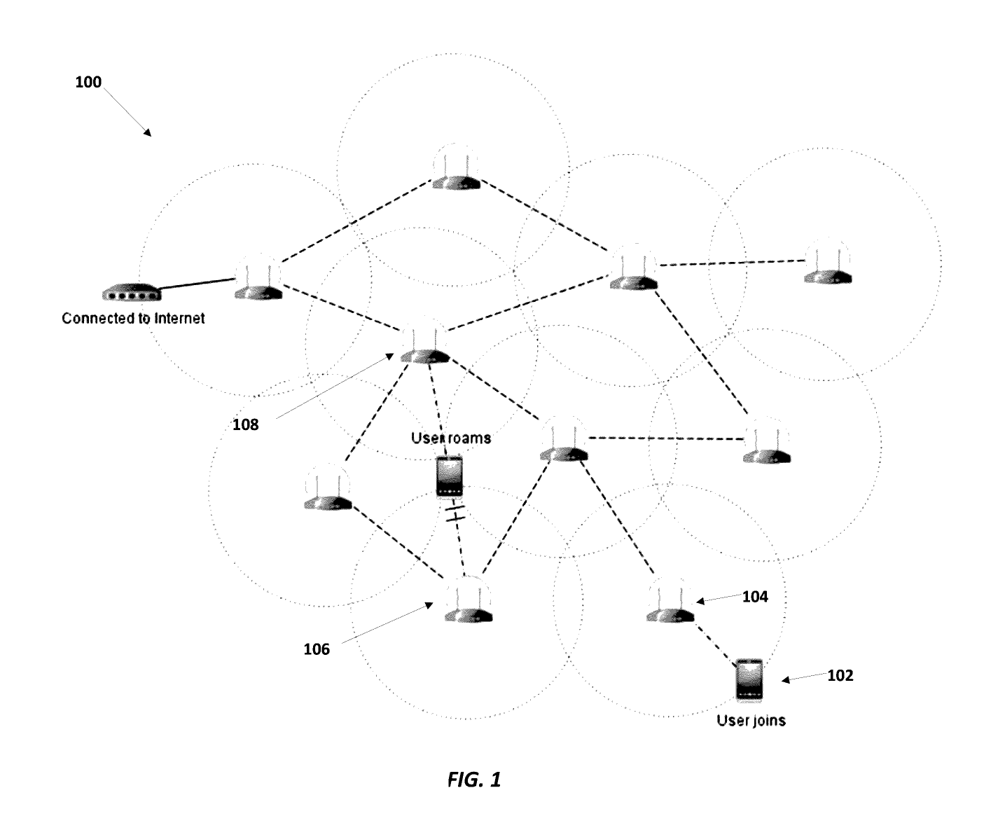

The present disclosure proposes methods and system for enhancing user services during roaming in wireless mesh networks, such as wireless mesh network 100 depicted in FIG. 1. The present disclosure focuses on updating user services, enhancing user services, and providing a better user experience of roaming through user profile propagation in wireless mesh networks. In some embodiments, the present disclosure solves the problem of prior art by propagation of user profile information before users move from coverage of one WMR to the coverage of another WMR.

The present disclosure provides a mechanism to propagate user profiles from a wireless mesh router (WMR) to nearby WMRs to enhance user services during user roaming. The main features of the present disclosure include:

1. Distributed Approach.

When a user device (e.g., user device 102 of FIG. 1) joins a wireless mesh network (e.g., wireless mesh network 100 of FIG. 1) and the user services for this user are updated on a WMR (e.g., WMR 104), related information is propagated to adjacent WMRs. After the adjacent WMRs receive the information, their user services are updated and the information may be propagated continuously under certain criteria. These criteria provide a way to safeguard the information propagation to prevent overloading of the network and to remove redundant information.

When the user device moves from the coverage of a first WMR (e.g., WMR 106) to a second WMR (e.g., WMR 108), the user services will already have been updated on the second WMR so that the user device is treated exactly as how the first WMR (e.g., through which the user joins the wireless mesh network) treats it. For example, the first WMR and the second WMR provide the same QoS and/or security level to the user device. When the user services change again, the updates are propagated in the same way described above, based on certain criteria.

Under the distributed approach, a centralized server is not required for data propagation.

2. Location-Based Approach.

Since a user device is at only one location at any given time and it will only move to adjacent locations, the user profile can be only propagated to the adjacent WMRs. This not only reduces the bandwidth consumption by the data propagation, but also reduces the resource requirement in each WMR and thus prevents performance drop of the WMRs.

The distributed approach and the location-based approach are both advantageous as they enable WMRs in wireless mesh network to provide smoother transitions when a user device roam across the network.

The proposed methods of the present disclosure may be deployed in real wireless mesh network environment, including captive portal, security, and the like, as discussed below.

User services, such as firewalls, are important in wireless mesh networks. The user services can help to allocate network resources to users fairly by limiting and shaping user traffic, monitor network usage for evaluation, secure the network by detection and prevention of network attack. According to present disclosure, the user services on WMRs adapt to user movement and the user services are updated based on predefined features and parameters.

The present disclosure may be adapted to various applications, for example, captive portal. Captive portal requires web-based user login to join the network. The redirection to the portal login page is usually done by setting firewall rules at WMRs. After a user logs in at a WMR, the firewall rules would be updated for that user at the WMR and the user can access the Internet through the wireless mesh network. When the user moves to the coverage of another WMR, without the firewall rule propagation, the user has to log in again. According to present disclosure, the user can roam across the network without additional actions such as typing and button clicks.

Another exemplary application of the present disclosure is network security. Whenever a WMR detects an attack and sets up firewall rules, adjacent WMRs would update their firewall rules as well, thus preventing the attack from the same user when the user moves to another WMR.

Network resources allocation and bandwidth shaping is an important feature in wireless mesh network. Unauthenticated and/or abnormal usage can be avoided right at the WMR, thus ensuring the wireless mesh network backbone is not overloaded. When a user device roams to a second WMR in the wireless mesh network, the second WMR has its firewall rules ready by classifying the user to a particular group for network resources allocation. The user would not suffer from usage limitation caused by the firewall rule setup time at the newly associated WMR.

In some embodiments, a method and system of user profile propagation in wireless mesh network to enhance user services and user experience in roaming are proposed.

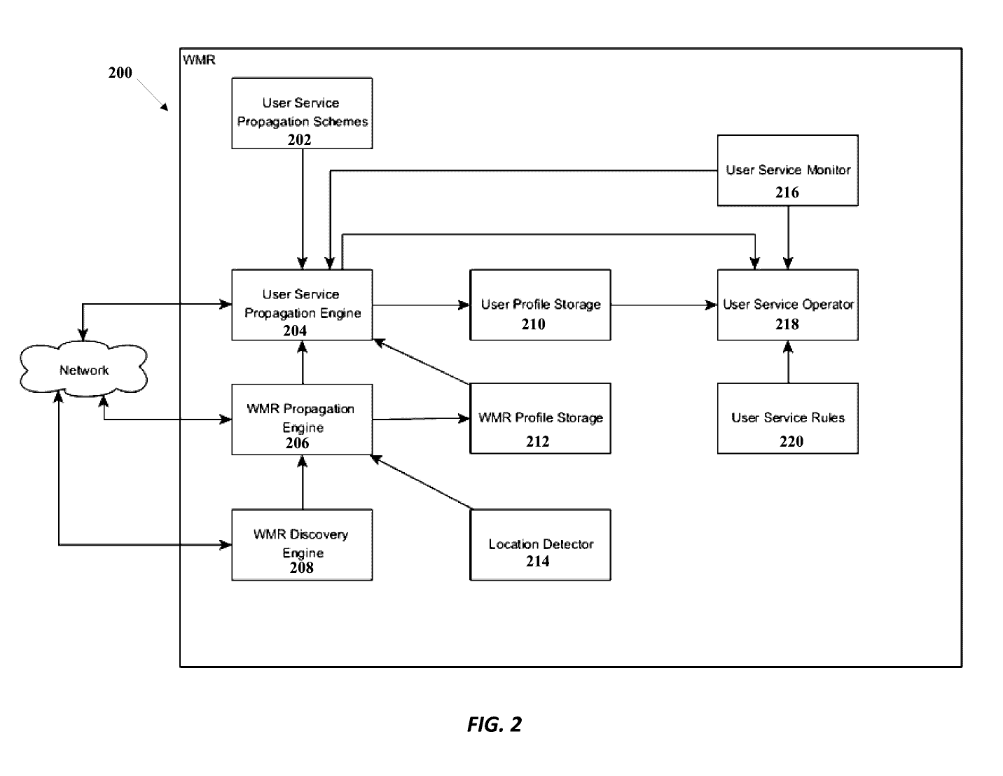

FIG. 2 depicts an exemplary system according to one embodiment of the present disclosure. Exemplary system 200 comprises units or components of User Service Propagation Schemes 202, User Service Propagation Engine 204, WMR Propagation Engine 206, WMR Discovery Engine 208, User Profile Storage 210, WMR Profile Storage 212, Location Detector 214, User Service Monitor 216, User Service Operator 218, and User Service Rules 220 connected in an exemplary manner as shown.

In some instances, User Service Propagation Engine 204 is a program that decides how to route a particular set of user services within a wireless mesh network based on User Service Propagation Schemes 202 and user profile data stored in User Profile Storage 210. In some instances, User Service Propagation Engine 204 resides on a WMR. In some instances, User Service Propagation Engine 204 is an executable or program running on top of an embedded OS and its structure could be similar to the one as shown in FIG. 2. User Service Propagation Engine 204 may communicate with an adjacent WMR and devices of the same wireless mesh network through a proprietary protocol containing at least one of the following: the user ID (if available), user MAC address, user IP, resident WMR ID, and login state.

In some instances, User Service Propagation Schemes 202 may be a set of pre-defined rules that decide how to route a particular set of user services within a wireless mesh network based on the inputted user profile. User Service Propagation Schemes 202 may be resident on each WMR, and is updated by a server connected to the wireless mesh network. In some instances, its structure may be a set of pre-defined rules stored in the database.

In some instances, User Profile Storage 210 is a database containing the profile of a user accessing the wireless mesh network. User Profile Storage 210 may be located within a WMR and is updated by a server connected to the wireless mesh network.

User Service Monitor 216 either actively monitors for occurrence of certain events or is passively triggered by the events. Examples of event include wireless client association, intrusion detection, captive portal user actions. User Service Monitor 216 is coupled to User Service Operator 218 and User Service Propagation Engine 204.

On receiving user updates or events, User Service Propagation Engine 204 preferably accesses User Service Propagation Schemes 202 and User Profile Storage 210 to determine and generate a set of user updates and profiles. User Service Propagation Engine 202 would propagate the user updates to other WMRs. In one preferred embodiment, user updates include the user MAC address, timestamp, service type, time-to-live, etc.

Whenever User Service Propagation Engine 204 receives data from another WMR, the data is forwarded only if it fulfills some criteria.

(i) There is new information from the received data;

(ii) The origin (or distance) of the data is not “far away”.

In some instances, the measure of distance can be done by time-to-live or location values. User Service Propagation Engine 204 would resolve any conflicts among received user updates. The processed user updates will be stored into User Profile Storage 210.

Since the hardware and software configurations of each WMR vary, the user service updated on each WMR can be different. Hence User Service Operator 218 preferably access User Service Rules 220 and User Profile Storage 210 on updating.

Besides, a centralized management of User Profile is not necessary, or it can be an assisting method on top of this distributed approach. Distributed approach can save the network resources in data transmission across wireless mesh network and more tolerant to data loss during transmission.

In some embodiments, location-based approach can be used to reduce the resource usage in each WMR. During roaming, the user will only move from a WMR to a nearby WMR. With a good measure of the adjacencies among the WMRs, location-based propagation is appropriate. In one preferred embodiment, number of hops among WMRs is a simple distance measure from user location to a WMR. With additional information such as GPS location, roads and maps etc., a more precise distance measure can be obtained for the propagation of user profile.

In some preferred embodiments, WMR Propagation Engine 206 stores a subset of WMR Profiles include number of hops away, location, supported service types, IP address etc. WMR Propagation Engine 206 communicates with directly linked WMRs in WMR Profile exchange. WMR Profile propagation can be location-based to reduce network and WMR resource usage.

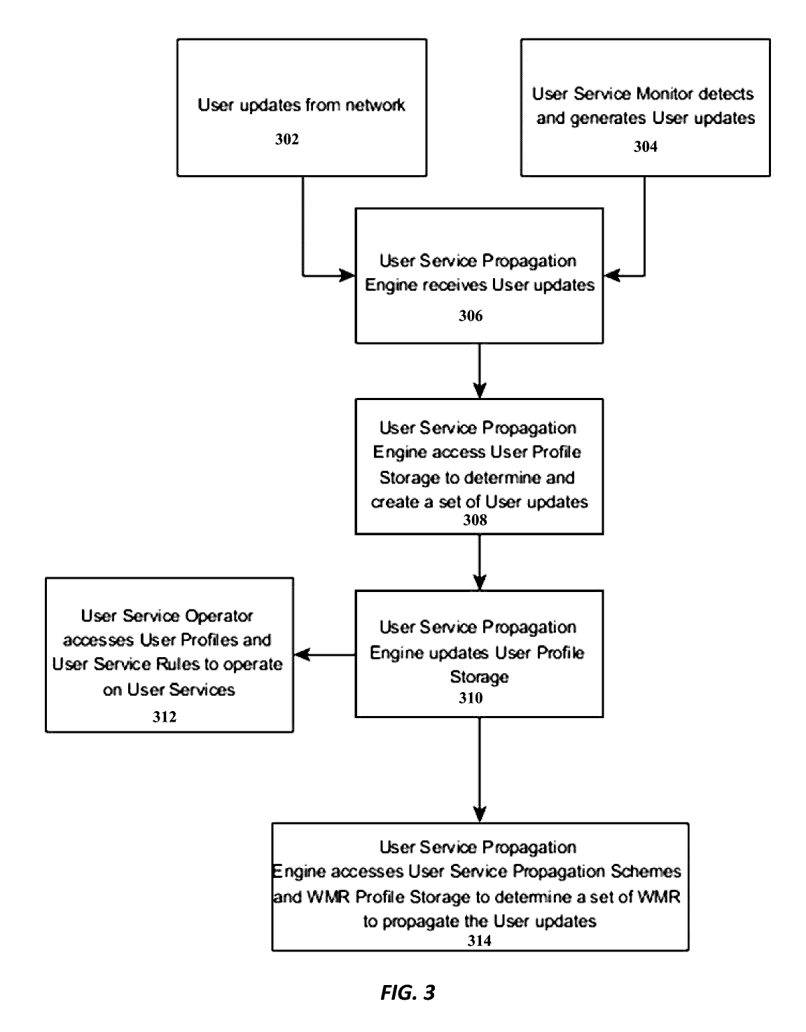

FIG. 3 illustrates a flow chart of exemplary flow of process for propagation of user profile according to some embodiments of the present disclosure. At block 302, User updates are generated and/or detected from network. At block 304, User Service Monitor detects and generates User updates. At block 306, User Service Propagation Engine receives User updates. At block 308, User Service Propagation Engine accesses User Profile Storage to determine and create a set of User updates. At block 310, User Service Propagation Engine updates User Profile Storage. At block 312, User Service Operator accesses User Profiles and User Service Rules to operate on User Services. At block 314, User Service Propagation Engine accesses User Service Propagation Schemes and WMR Profile Storage to determine a set of WMR to propagate the User updates.

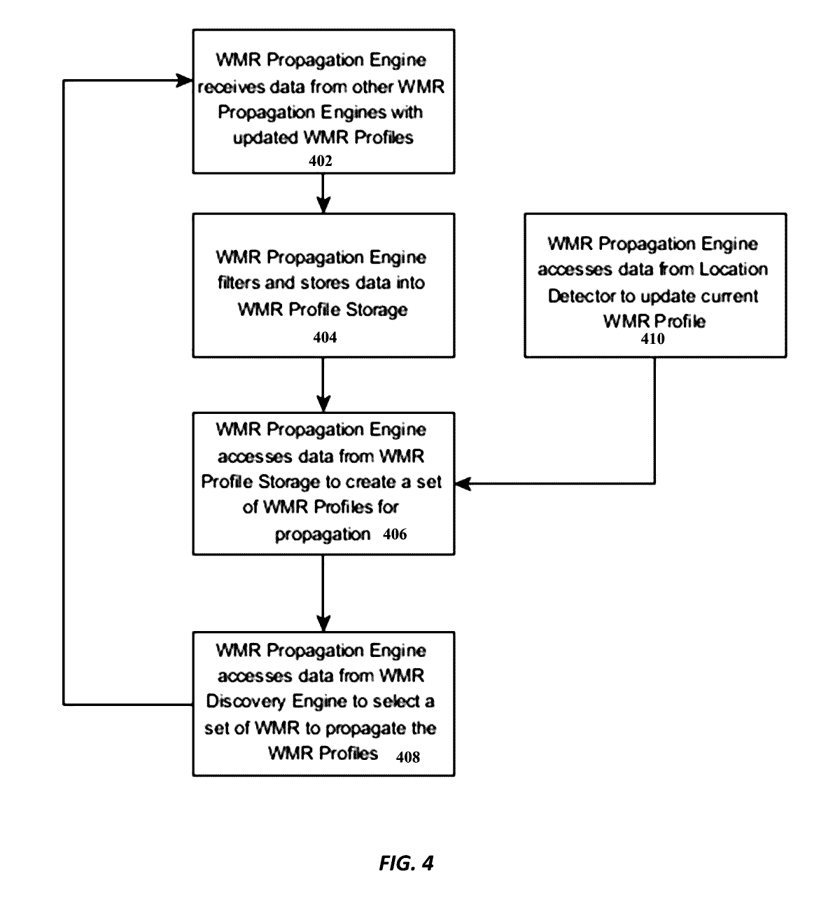

FIG. 4 illustrates a flow chart of exemplary flow of process for propagation of WMR Profiles according to some embodiments of the present disclosure. At bock 402, WMR Propagation Engine receives data from other WMR Propagation Engines with updated WMR Profiles. At block 404, WMR Propagation Engine filters and stores data into WMR Profile Storage. At block 410, WMR Propagation Engine accesses data from Location Detector to update current WMR Profile. At block 406, WMR Propagation Engine accesses data from WMR Profile Storage to create a set of WMR Profiles for propagation. At block 408, WMR Propagation Engine accesses data from WMR Discovery Engine to select a set of WMR to propagate the WMR Profiles.

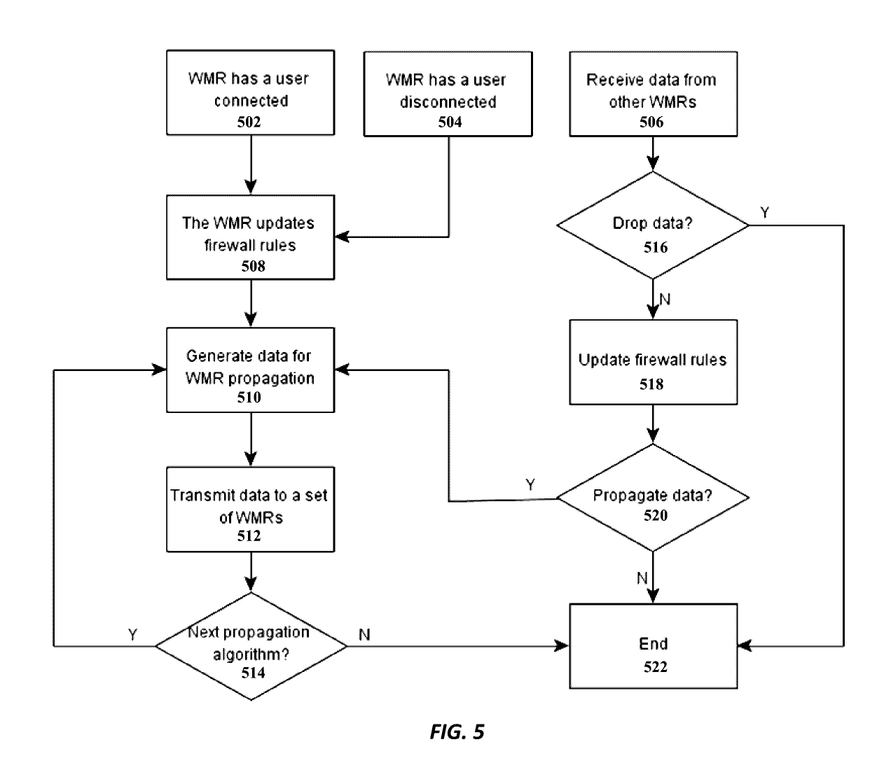

FIG. 5 illustrates a flow chart of exemplary flow of process for data propagation with firewall related services among WMRs according to some embodiments of the present disclosure. At block 502, WMR has a user connected. At block 504, WMR has a user disconnected. At block 508, the WMR updates firewall rules. At block 510, data is generated for WMR propagation. At block 512, data is transmitted to a set of WMRs. At block 514, the system determines whether to proceed with a next propagation. Depending on the determination, the process may proceed to block 510 or end at block 522.

FIG. 5 further illustrates that, at block 506, data is received from other WMRs. At block 516, the system makes a first determination of whether to drop the data. If the result of the determination is yes, the process proceeds to block 518, where firewall rules are updated. At block 520, the system makes a second determination of whether to propagate data. If the result of the determination is yes, the process proceeds to block 510. If the result of either the first determination at 516 or the second determination at 520 is no, the process ends at block 522.

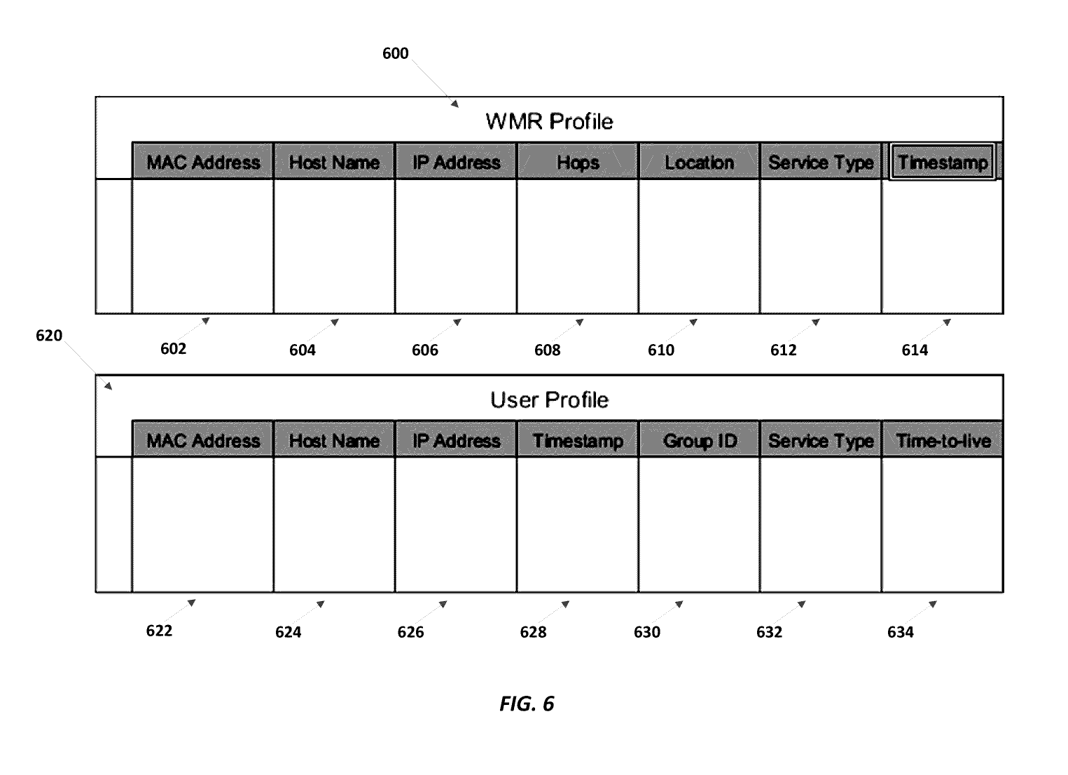

FIG. 6 illustrates an exemplary WMR Profile Storage table and an exemplary User Profile Storage table according to an embodiment of the present disclosure. As depicted, WMR Profile Storage table 600 includes MAC Address 602, Host Name 604, IP Address 606, Hops 608, Location 610, Service Type 612, and Timestamp 614. User Profile Storage table 620 includes MAC Address 622, Host Name 624, IP Address 626, Timestamp 628, Group ID 630, Service Type 632, and Time-to-live 634.

In some embodiments of the present disclosure, a WMR is to transmit user information of a mobile user device to a plurality of neighboring WMRs of the wireless mesh network while the mobile user device is in data connection with that WMR and one of the plurality of neighboring WMRs will take over data connection with that mobile user device using the received user information when the mobile user device moves out of connection with the WMR.

In some embodiments, a WMR is to receive and store user information of a mobile user device connected to a neighboring WMR of the wireless mesh network while the mobile user device is in data connection with that neighboring WMR and that WMR will take over data connection with that mobile user device using the received user information when the mobile user device moves out of connection with that neighboring WMR.

While the disclosure has been described herein with reference to examples, the examples are not intended and should not be used to limit the scope of disclosure.

What is claimed is:

1. A method for accessing a wireless mesh network, comprising:
identifying, at a wireless mesh router, a neighboring wireless mesh router that is in communication with the wireless mesh router;
storing, at the wireless mesh router, identification data for the neighboring wireless mesh router;
sending, from the wireless mesh router to the neighboring wireless mesh router, data of a mobile user device while the mobile user device has a connection with the wireless mesh router, wherein the data of the mobile device comprises a user profile; and
transferring the connection for the mobile user device from the wireless mesh router to the neighboring wireless mesh router, wherein the neighboring wireless mesh network router provides access to the wireless mesh network to the mobile user device based on the data of the mobile user device.

2. The method of claim 1, wherein the sending of data of the mobile user device to the neighboring wireless mesh router occurs prior to the mobile user device being in a service region of the neighboring wireless mesh router.

3. The method of claim 1, wherein sending the data of the mobile user device to the neighboring wireless mesh router includes transmitting a unicast message.

4. The method of claim 1, wherein sending the data of the mobile user device to the neighboring wireless mesh router occurs based on a change in the data, wherein the data includes network connection status.

5. The method of claim 4, wherein the network connection status comprises information indicative of presence of a connection, real time signal strength, interference level, connection healthiness, or a combination thereof.

6. The method of claim 1, wherein identifying the neighboring wireless mesh router that is in communication with the wireless mesh router includes determining that the wireless mesh router is a single hop connection with the neighboring wireless mesh router.

7. The method of claim 1, wherein the identification data includes a MAC address of the neighboring wireless mesh router.

8. A method for accessing a wireless mesh network, comprising:
identifying, at a first wireless mesh router, a neighboring wireless mesh router that is in communication with the wireless mesh router;
storing, at the wireless mesh router, identification data for the neighboring wireless mesh router;
receiving, from the neighboring wireless mesh router at the wireless mesh router, first data of a mobile user device while the mobile user device has a connection with the neighboring wireless mesh router, wherein the first data of the mobile user device comprises a user profile;
transferring the connection for the mobile user device from the neighboring wireless mesh router to the wireless mesh router, wherein the wireless mesh network router provides access to the wireless mesh network to the mobile user device based on the first data of the mobile user device.

9. The method of claim 8, wherein identifying the neighboring wireless mesh router that is in communication with the wireless mesh router includes determining that the wireless mesh router is a single hop connection with the neighboring wireless mesh router.

10. The method of claim 8, further comprising:
receiving, at the first wireless mesh network router, second data from a second wireless mesh router;
determining whether a second wireless mesh router is in the neighborhood of the first wireless mesh router; and
in accordance with a determination that the second wireless mesh router is not in the neighborhood of the first wireless mesh router, discarding the second data.

11. The method of claim 8, wherein the identification data includes a MAC address of the neighboring wireless mesh router.

12. The method of claim 1, wherein the data of the mobile user device comprises user services data.

13. The method of claim 8, wherein the first data of the mobile user device comprises user services data.

14. A wireless mesh router for accessing a wireless mesh network, the wireless mesh router comprising:
one or more processors;
a memory coupled to the one or more processors; and
one or more programs, wherein the one or more programs are stored in the memory and configured to be executed by the one or more processors, the one or more programs including instructions for:
identifying, at the wireless mesh router, a neighboring wireless mesh router that is in communication with the wireless mesh router;
storing, at the wireless mesh router, identification data for the neighboring wireless mesh router;
sending, from the wireless mesh router to the neighboring wireless mesh router, data of a mobile user device while the mobile user device has a connection with the wireless mesh router, wherein the data of the mobile user device comprises a user profile; and
transferring the connection for the mobile user device from the wireless mesh router to the neighboring wireless mesh router, wherein the neighboring wireless mesh network router provides access to the wireless mesh network to the mobile user device based on the data of the mobile user device.

15. A wireless mesh router for accessing a wireless mesh network, the wireless mesh router comprising:
one or more processors;
a memory coupled to the one or more processors; and
one or more programs, wherein the one or more programs are stored in the memory and configured to be executed by the one or more processors, the one or more programs including instructions for:
identifying, at the wireless mesh router, a neighboring wireless mesh router that is in communication with the wireless mesh router;
storing, at the wireless mesh router, identification data for the neighboring wireless mesh router;
receiving, from the neighboring wireless mesh router at the wireless mesh router, first data of a mobile user device while the mobile user device has a connection with the neighboring wireless mesh router, wherein the first data comprises a user profile;
transferring the connection for the mobile user device from the neighboring wireless mesh router to the wireless mesh router, wherein the wireless mesh network router provides access to the wireless mesh network to the mobile user device based on the first data of the mobile user device.

16. A non-transitory computer-readable storage medium storing one or more programs, the one or more programs comprising instructions for accessing a wireless mesh network, which when executed by one or more processors of an electronic device, cause the device to:
identify, at a wireless mesh router, a neighboring wireless mesh router that is in communication with the wireless mesh router;
store, at the wireless mesh router, identification data for the neighboring wireless mesh router;
send, from the wireless mesh router to the neighboring wireless mesh router, data of a mobile user device while the mobile user device has a connection with the wireless mesh router, wherein the data of the mobile user device comprises a user profile; and
transfer the connection for the mobile user device from the wireless mesh router to the neighboring wireless mesh router, wherein the neighboring wireless mesh network router provides access to the wireless mesh network to the mobile user device based on the data of the mobile user device.

17. A non-transitory computer-readable storage medium storing one or more programs, the one or more programs comprising instructions for accessing a wireless mesh network, which when executed by one or more processors of an electronic device, cause the device to:
identify, at a first wireless mesh router, a neighboring wireless mesh router that is in communication with the wireless mesh router;
store, at the wireless mesh router, identification data for the neighboring wireless mesh router;
receive, from the neighboring wireless mesh router at the wireless mesh router, first data of a mobile user device while the mobile user device has a connection with the neighboring wireless mesh router, wherein the first data of the mobile user device comprises a user profile;
transfer the connection for the mobile user device from the neighboring wireless mesh router to the wireless mesh router, wherein the wireless mesh network router provides access to the wireless mesh network to the mobile user device based on the first data of the mobile user device.
